(19) United States
(12) Patent Application Publication
(10) Pub. No.: US 2026/0269149 A1
(43) Pub. Date: Sep. 10, 2026

(54) SWITCH

(71) Applicant: Mitsubishi Electric Corporation, Tokyo (JP)

(72) Inventors: Kazuma KAWAHARA, Tokyo (JP); Katsuki HOTTA, Tokyo (JP); Tatsuhiro ABE, Tokyo (JP); Yuta SAGARA, Tokyo (JP)

(73) Assignee: Mitsubishi Electric Corporation, Tokyo (JP)

(21) Appl. No.: 19/167,851

(22) PCT Filed: Apr. 18, 2023
(86) PCT No.: PCT/JP2023/015477

§ 371 Date: Sep. 23, 2025

(51) Int. Cl. H01H 9/34; H01H 9/36; H01H 9/44; H01H 50/00; H01H 50/54; H01H 73/18

(52) U.S. Cl. CPC H01H 9/346; H01H 9/36; H01H 9/44; H01H 50/54; H01H 2009/348; H01H 2009/365; H01H 50/002; H01H 73/18

(57) ABSTRACT

Included are: a fixed contact; a movable contact that comes into contact with and is separated from the fixed contact along with rotational movement of a movable contactor in a rod shape; and a grid made of metal disposed to face the fixed contact in a second direction that is a direction orthogonal to a first direction and along a longitudinal direction of the movable contactor, the first direction being a movable direction of the movable contact, and the grid returns a gas flow back around the movable contact and the fixed contact, the gas flow being generated between the movable contact and the fixed contact during an opening operation in which the movable contact is moved away from the fixed contact, and flowing along the second direction from the movable contact and the fixed contact toward the grid.

### FIELD

The present disclosure relates to a switch disposed between a power supply and a load.

### BACKGROUND

A contact switch including a grid which is a metal member configured by three surfaces and surrounding a movable contact and a fixed contact from three directions is conventionally known. In such a contact switch including a grid, an electromagnetic force acts on an arc generated between a movable contact and a fixed contact during an opening operation in which the movable contact is moved away from the fixed contact. The arc is pulled toward the grid from between the movable contact and the fixed contact and extended, thereby being divided. Thus, the contact switch including the grid can quickly cut off the arc generated during the opening operation.

Patent Literature 1 discloses a contact switch in which left and right return flow side plates standing left and right are disposed inside a grid block. The contact switch disclosed in Patent Literature 1 directs an arc into the grid block through the inside of the left and right return flow side plates, and causes a gas flow of a hot gas generated between a movable contact and a fixed contact to be returned around the movable contact and the fixed contact by the left and right return flow side plates. Since the hot gas generated during an opening operation has a lower temperature than the arc and has an arc cooling effect, the extinction of the arc can be promoted by returning the hot gas back around the movable contact and the fixed contact.

### Citation List

### Patent Literature

Patent Literature 1: Japanese Patent Application Laid-open No. S56-036815

### SUMMARY OF INVENTION

### Problem to Be Solved by the Invention

In the contact switch disclosed in Patent Literature 1, since the grid is formed of a plurality of plate-shaped members, the hot gas leaks from a gap between the plate-shaped members, and the effect of promoting the extinction of the arc is reduced. Therefore, the contact switch disclosed in Patent Literature 1 has room for further improving performance in cutting off the arc generated during the opening operation.

The present disclosure has been made in view of the above, and an object thereof is to provide a switch having high performance in cutting off an arc generated during an opening operation.

### Means to Solve the Problem

To solve the above described problems and achieve the object a switch according to the present disclosure includes: a fixed contact; a movable contact installed on a movable contactor that is rotationally movable having a rod-shape and separated from the fixed contact along with rotational movement of the movable contactor; and a grid made of metal disposed to face the fixed contact in a second direction that is a direction orthogonal to a first direction and along a longitudinal direction of the movable contactor, the first direction being a movable direction of the movable contact. The grid is adapted to return a gas flow back around the movable contact and the fixed contact, the gas flow being generated between the movable contact and the fixed contact during an opening operation in which the movable contact is moved away from the fixed contact, and flowing along the second direction from the movable contact and the fixed contact toward the grid.

### Effects of the Invention

According to the present disclosure, an effect is achieved that it is possible to provide a switch having high performance in cutting off an arc generated during an opening operation.

### BRIEF DESCRIPTION OF DRAWINGS

FIG. 1 is a top view of a switch according to a first embodiment.

FIG. 2 is a diagram schematically illustrating a cross section of the switch according to the first embodiment.

FIG. 3 is a top view of an internal structure of a Second-phase arc-extinguishing chamber of the switch according to the first embodiment.

FIG. 4 is a diagram schematically illustrating a cross section of the internal structure of the second-phase arc-extinguishing chamber of the switch according to the first embodiment.

FIG. 5 is a diagram illustrating a state in which an arc is generated between a movable contact and a fixed contact of the switch according to the first embodiment.

FIG. 6 is a perspective view of an internal structure of the second-phase arc-extinguishing chamber of the switch according to a second embodiment.

FIG. 7 is a top view of the internal structure of the second-phase arc-extinguishing chamber of the switch according to the second embodiment.

FIG. 8 is a top view of an internal structure of the second-phase arc-extinguishing chamber of the switch according to a first modification of the second embodiment.

FIG. 9 is a cross-sectional view of the internal structure of the second-phase arc-extinguishing chamber of the switch according to the first modification of the second embodiment.

FIG. 10 is a top view of an internal structure of the second-phase arc-extinguishing chamber of the switch according to a second modification of the second embodiment.

FIG. 11 is a cross-sectional view of the internal structure of the second-phase arc-extinguishing chamber of the switch according to the second modification of the second embodiment.

FIG. 12 is a top view of an internal structure of the second-phase arc-extinguishing chamber of the switch according to a third embodiment.

FIG. 13 is a top view of an internal structure of the second-phase arc-extinguishing chamber of the switch according to a fourth embodiment.

FIG. 14 is a perspective view of an internal structure of the second-phase arc-extinguishing chamber of the switch according to a modification of the fourth embodiment.

FIG. 15 is a top view of an internal structure of the second-phase arc-extinguishing chamber of the switch according to a fifth embodiment.

FIG. 16 is a perspective view of a grid of the switch according to a sixth embodiment.

FIG. 17 is a perspective view of an internal structure of the second-phase arc-extinguishing chamber of the switch according to a seventh embodiment.

### DESCRIPTION OF EMBODIMENTS

Hereinafter, a switch according to each embodiment will be described in detail with reference to the drawings.

### First Embodiment

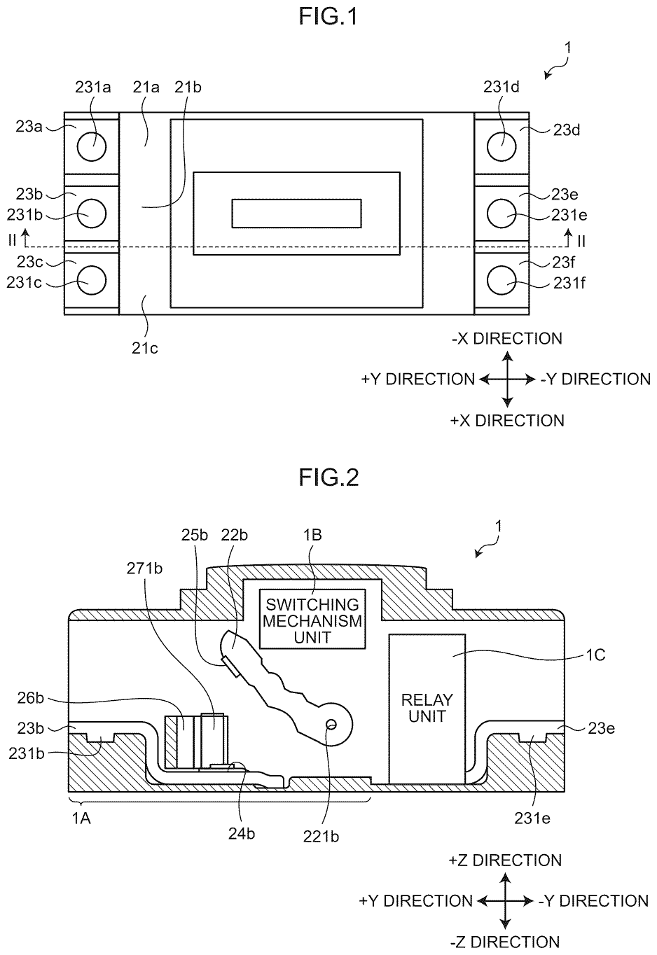

FIG. 1 is a top view of a switch according to a first embodiment. FIG. 2 is a diagram schematically illustrating a cross section of the switch according to the first embodiment. FIG. 2 schematically illustrates a cross section of a switch 1 taken along line II-II in FIG. 1. A Y direction, a Z direction, and an X direction are defined as directions orthogonal to each other, as illustrated in FIGS. 1 and 2. Specifically: a first direction which is a direction in which a movable contact 25b and a fixed contact 24b to be described later come into contact with each other and are separated from each other and is a movable direction of the movable contact 25b is defined as the Z direction; a second direction which is a direction orthogonal to the Z direction and along a longitudinal direction of a movable contactor 22b to be described later is defined as the Y direction; and a third direction which is a direction orthogonal to the Z direction and the Y direction and along a lateral direction of the movable contactor 22b to be described later is defined as the X direction. The Z direction is a generic term for a +Z direction and a −Z direction indicating directions opposite to each other; the Y direction is a generic term for a +Y direction and a −Y direction indicating directions opposite to each other; and the X direction is a generic term for a +X direction and a −X direction indicating directions opposite to each other. In the following description, a case where the +Z direction corresponds to an upward direction, the −Z direction corresponds to a downward direction, the +Y direction corresponds to a forward direction, the −Y direction corresponds to a backward direction, the +X direction corresponds to a left direction, and the −X direction corresponds to a right direction will be taken as an example, but this example does not limit a posture of the switch 1 to be installed.

The switch 1 is, for example, a contact switch configured for three-phase power supplies, and includes three arc-extinguishing chambers. Because the switch 1 has the same structure for each of phases, only the structure of one phase will be described below. Other phases, for which redundant descriptions will be omitted, each has a similar structure.

As illustrated in FIGS. 1 and 2, the switch 1 includes: a contact unit 1A including a first-phase arc-extinguishing chamber 21a, a second-phase arc-extinguishing chamber 21b, and a third-phase arc-extinguishing chamber 21c adjacent to each other; a switching mechanism unit 1B that drives the contact unit 1A; and a relay unit 1C that operates the switching mechanism unit 1B when detecting overcurrent.

Wiring of one phase of a three-phase power supply (not illustrated) is connected to fixed contactors 23a, 23b, and 23c via power supply-side terminals 231a, 231b, and 231c, respectively; and wiring of a load (not illustrated) is connected to fixed terminals 23d, 23e, and 23f via load-side terminals 231d, 231e, and 231f, respectively. The first-phase arc-extinguishing chamber 21a, the second-phase arc-extinguishing chamber 21b, and the third-phase arc-extinguishing chamber 21c have the same structure. Therefore, the structure of the second-phase arc-extinguishing chamber 21b will be mainly described below, and redundant descriptions of the structures of the first-phase arc-extinguishing chamber 21a and the third-phase arc-extinguishing chamber 21c will be omitted.

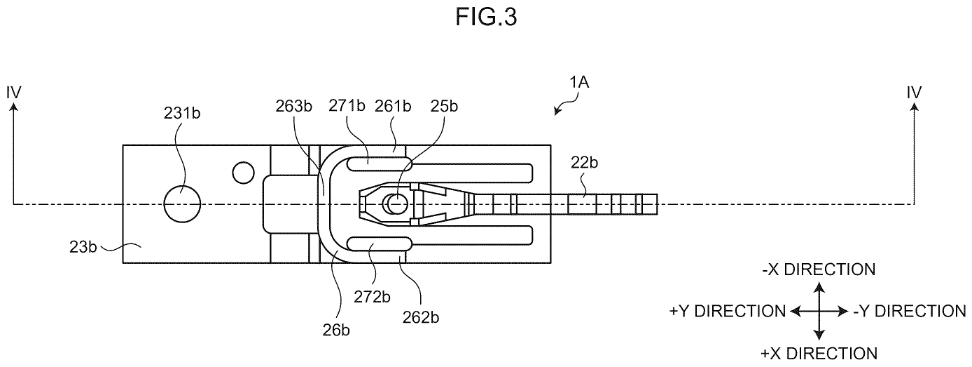

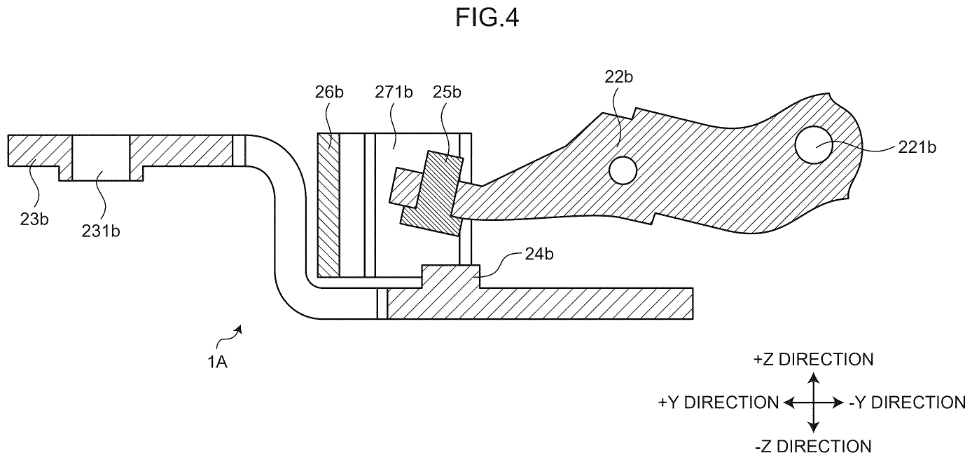

FIG. 3 is a top view of an internal structure of the second-phase arc-extinguishing chamber of the switch according to the first embodiment. FIG. 4 is a diagram schematically illustrating a cross section of the internal structure of the second-phase arc-extinguishing chamber of the switch according to the first embodiment. FIG. 4 illustrates a cross-sectional structure of the internal structure of the second-phase arc-extinguishing chamber 21b taken along line IV-IV in FIG. 3. FIGS. 3 and 4 illustrate a positional relationship among: the movable contactor 22b provided with the movable contact 25b; the fixed contactor 23b provided with the fixed contact 24b; and a grid 26b and two insulators 271b and 272b provided in the vicinity thereof, on a power supply side of one phase of the three-phase power supply. Power supply sides of the other two phases each has a similar structure, and thus redundant descriptions thereof will be omitted here.

The second-phase arc-extinguishing chamber 21b includes: the fixed contactor 23b provided with the fixed contact 24b; the movable contactor 22b provided with the movable contact 25b; the grid 26b mounted in the vicinity of the fixed contact 24b and the movable contact 25b; and the two insulators 271b and 272b mounted in the vicinity of the grid 26b.

The grid 26b is formed of a magnetic material such as iron. When a fault current is detected, the movable contact 25b is moved away from the fixed contact 24b, and thereby a hot gas directed in the +Y direction from the movable contact 25b or the fixed contact 24b is generated together with an arc between the movable contact 25b and the fixed contact 24b. The grid 26b forms a flow path for directing, in ±X directions and the −Y direction of the movable contact 25b or the fixed contact 24b, the hot gas directed toward a forward side from the movable contact 25b or the fixed contact 24b. That is, the grid 26b has a function of reversing a flow direction of the hot gas.

As illustrated in FIGS. 3 and 4, the grid 26b is disposed on an extension line in the longitudinal direction of the movable contactor 22b, and has a plurality of surfaces surrounding the periphery of the fixed contact 24b. In detail, as illustrated in FIG. 3, the grid 26b includes two side surface portions 261b and 262b facing each other and covering the fixed contact 24b, and a coupling portion 263b coupling the side surface portions 261b and 262b, and has a U shape in top view. The side surface portions 261b and 262b sandwich the fixed contact 24b in the X direction orthogonal to the Z direction which is a movable direction of the movable contactor 22b. The coupling portion 263b faces the fixed contact 24b in the Y direction orthogonal to the Z direction which is the movable direction. The coupling portion 263b has dimension in the Z direction which is the movable direction of the movable contactor 22b larger than or equal to a dimension in the Y direction. As illustrated in FIGS. 3 and 4, in a state in which the movable contact 25b is located near the fixed contact 24b, the movable contact 25b is covered together with the fixed contact 24b, by the two side surface portions 261b and 262b and the coupling portion 263b.

The two insulators 271b and 272b are disposed between the fixed contact 24b and the grid 26b inside the grid 26b so that at least a part of the coupling portion 263b of the grid 26b is exposed when viewed from the fixed contact 24b. The inside of the grid 26b is a region surrounded on three sides by the coupling portion 263b and the two side surface portions 261b and 262b. Here, it is not always necessary to dispose both of the two insulators 271b and 272b, and it is sufficient that at least one of the two insulators is disposed.

The hot gas flowing in the +Y direction from the movable contact 25b and the fixed contact 24b at the time of detecting the fault current changes a traveling direction into the ±X directions when hitting the coupling portion 263b, and further changes the traveling direction into the −Y direction along the side surface portions 261b and 262b and the insulators 271b and 272b. Therefore, the hot gas generated between the movable contact 25b and the fixed contact 24b is returned back around the movable contact 25b and the fixed contact 24b by the grid 26b.

The movable contactor 22b is driven by the switching mechanism unit 1B, and rotates about a drive shaft 221b illustrated in FIG. 4. In detail, at the time of energization, the switching mechanism unit 1B rotates the movable contactor 22b about the drive shaft 221b until the movable contact 25b and the fixed contact 24b come into contact with each other. When detecting the fault current, the relay unit 1C operates the switching mechanism unit 1B to rotate the movable contactor 22b about the drive shaft 221b in a direction in which the movable contact 25b is moved away from the fixed contact 24b.

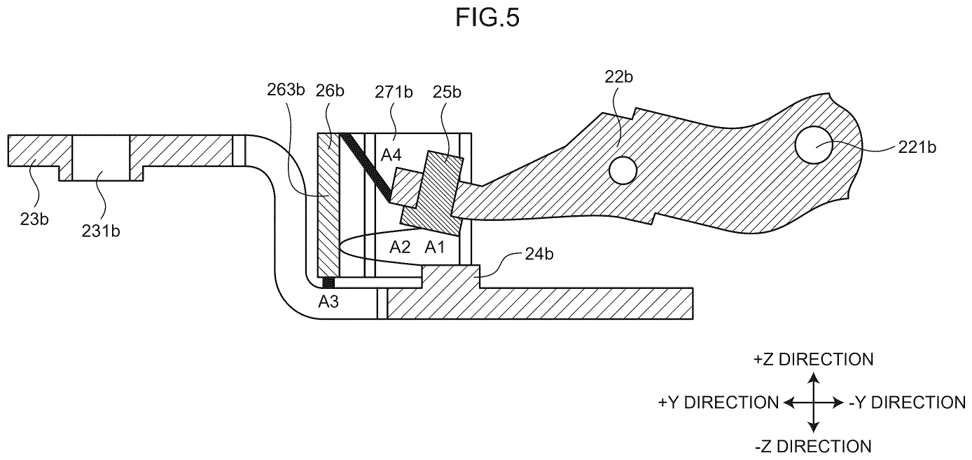

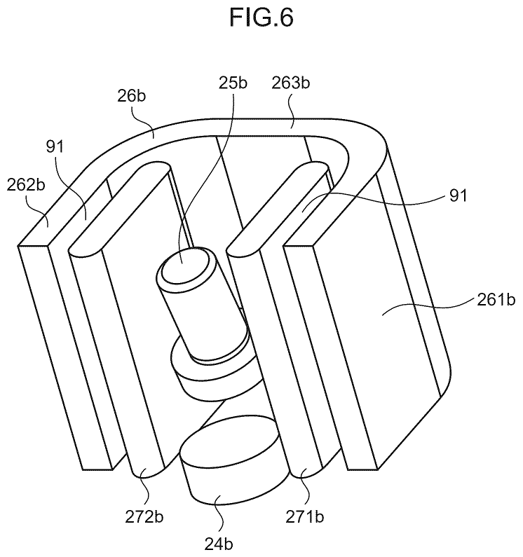

When the relay unit 1C operates the switching mechanism unit 1B and the movable contact 25b is moved away from the fixed contact 24b at the time of detecting overcurrent, an arc is generated between the movable contact 25b and the fixed contact 24b. A process of cutting off the arc generated between the movable contact 25b and the fixed contact 24b will be described. FIG. 5 is a diagram illustrating a state in which an arc is generated between the movable contact and the fixed contact of the switch according to the first embodiment. Immediately after the movable contact 25b is moved away from the fixed contact 24b, an arc connecting the movable contact 25b and the fixed contact 24b is generated at position Al. In addition to the grid 26b causing an electromagnetic force to act on the arc in the +Y direction, the gas flow of the hot gas generated between the movable contact 25b and the fixed contact 24b and flowing in the +Y direction drives the arc, and thereby the arc having a shape pulled by the coupling portion 263b of the grid 26b moves to position A2 through between the insulators 271b and 272b. When the arc pulled toward the grid 26b comes into contact with the coupling portion 263b, a current flow into the grid 26b, and the arc moves to position A3 and position A4 and is divided. When the arc is divided, the cutting off of the arc generated between the movable contact 25b and the fixed contact 24b is completed.

The switch 1 according to the first embodiment drives the arc generated between the movable contact 25b and the fixed contact 24b in the +Y direction toward the grid 26b by the electromagnetic force, and drives the arc generated between the movable contact 25b and the fixed contact 24b in the +Y direction also by the gas flow of the hot gas generated between the movable contact 25b and the fixed contact 24b. Furthermore, the switch 1 according to the first embodiment can increase a driving force of the arc to improve the arc cooling effect by causing the gas flow of the hot gas of which traveling direction is changed at the coupling portion 263b to flow in the-Y direction along the side surface portions 261b and 262b of the grid 26b. Consequently, the switch 1 according to the first embodiment can quickly extend the arc to the grid 26b and divide the arc, and thus can complete the cutting off of the arc at a higher speed.

In addition, as illustrated in FIGS. 3 and 4, the switch 1 according to the first embodiment: has a configuration in which a dimension in the Z direction which is an operating direction of the movable contactor 22b is larger than or equal to a dimension in the Y direction which is an alignment direction of the fixed contact 24b and the coupling portion 263b; and includes the grid 26b having three or more surfaces. Therefore, it is possible to increase the volume of the magnetic material and strengthen the electromagnetic force acting on the arc. Therefore, in the switch 1 according to the first embodiment, the cutting off of the arc can be completed at a high speed by quickly extending and dividing the arc. In the switch 1 according to the first embodiment, since the insulators 271b and 272b are installed inside the grid 26b, it is possible to move the arc to the coupling portion 263b at least a part of which is exposed, with no contact of the arc with the side surface portions 261b and 262b of the grid 26b, and to complete the cutting off of the arc reliably.

### Second Embodiment

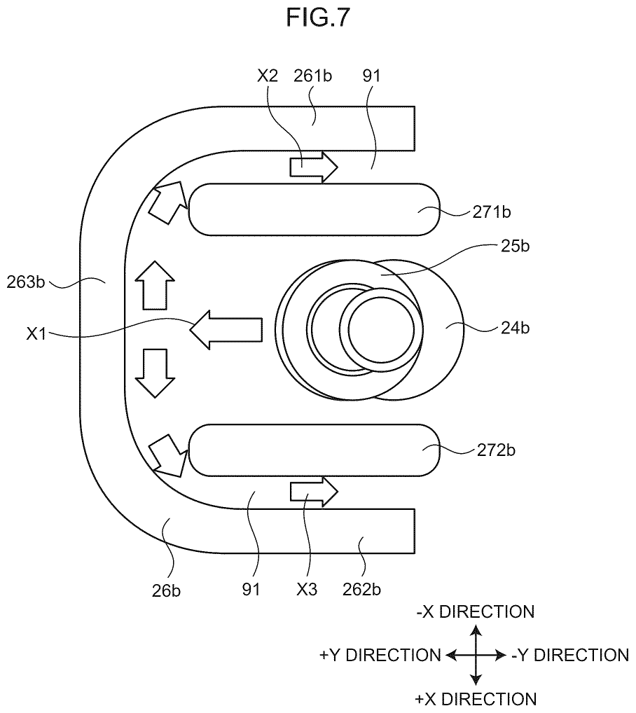

FIG. 6 is a perspective view of an internal structure of the second-phase arc-extinguishing chamber of the switch according to a second embodiment. FIG. 7 is a top view of the internal structure of the second-phase arc-extinguishing chamber of the switch according to the second embodiment. The switch 1 according to the second embodiment is different from the switch 1 according to the first embodiment in that a gap 91 is formed between each of the insulators 271b and 272b and the grid 26b. In the switch 1 according to the second embodiment, return flow path X1 is formed between the insulators 271b and 272b, a return flow path X2 is formed by the gap 91 between the side surface portion 261b and the insulator 271b, and a return flow path X3 is formed by the gap 91 between the side surface portion 262b and the insulator 272b.

Part of the hot gas generated together with the arc between the movable contact 25b and the fixed contact 24b during contact opening flows from the movable contact 25b and the fixed contact 24b toward the grid 26b in the +Y direction. The hot gas that has hit the coupling portion 263b branches off into the ±X directions orthogonal to the Z direction which is the movable direction of the movable contactor 22b. The hot gas flows along an inner surface of the grid 26b through the return flow path X2 and the return flow path X3 in the −Y direction which is opposite to the direction of the hot gas in the return flow path X1.

Since the gap 91 is formed between each of the insulators 271b and 272b and the grid 26b, an interval between the insulators 271b and 272b is narrower than that of the switch 1 according to the first embodiment. Therefore, the gas flow of the hot gas flowing in the +Y direction through the return flow path X1 formed between the insulators 271b and 272b is stronger than that of the switch 1 according to the first embodiment. Since the return flow paths X2 and X3 are formed between the insulators 271b and 272b and the side surface portions 261b and 262b, respectively, the gas flow of each of the hot gases flowing in the −Y direction along the side surface portions 261b and 262b and the insulators 271b and 272b is stronger than that of the switch 1 according to the first embodiment. Since the return flow path X1 and the return flow paths X2 and X3 are separated by the insulators 271b and 272b, there is no interference and counteraction between the hot gas flowing in the +Y direction and the hot gas flowing in the −Y direction.

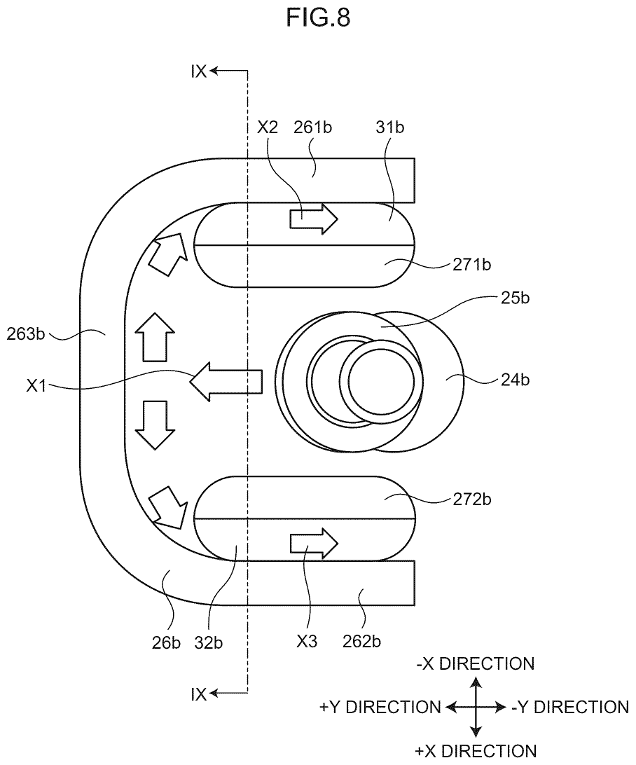

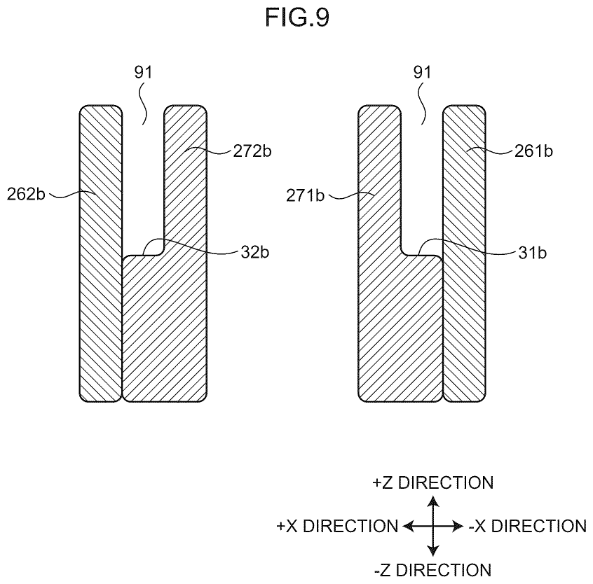

FIG. 8 is a top view of an internal structure of the second-phase arc-extinguishing chamber of the switch according to a first modification of the second embodiment. FIG. 9 is a cross-sectional view of the internal structure of the second-phase arc-extinguishing chamber of the switch according to the first modification of the second embodiment. FIG. 9 illustrates a cross section of the internal structure of the second-phase arc-extinguishing chamber 21b taken along line IX-IX in FIG. 8. In the switch 1 according to the first modification of the second embodiment, the insulators 271b and 272b have low portions 31b and 32b which are portions facing the side surface portions 261b and 262b and lower than the side surface portions 261b and 262b, respectively. A distance between each of the low portions 31b and 32b and the fixed contact 24b in the first direction is shorter than a distance between each of end portions of the side surface portions 261b and 262b in the first direction and the fixed contact 24b. In the switch 1 according to the first modification of the second embodiment, spaces above the low portions 31b and 32b each serve as the gap 91 to form the return flow paths X2 and X3.

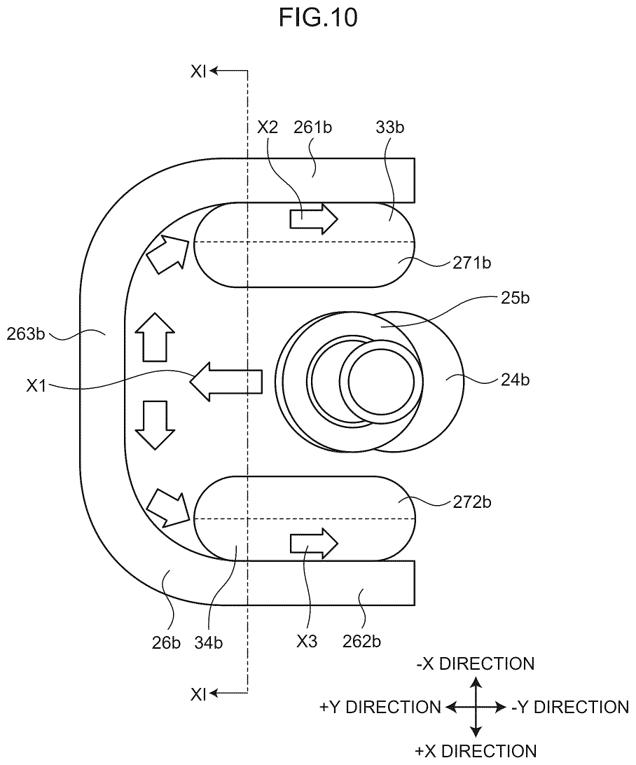

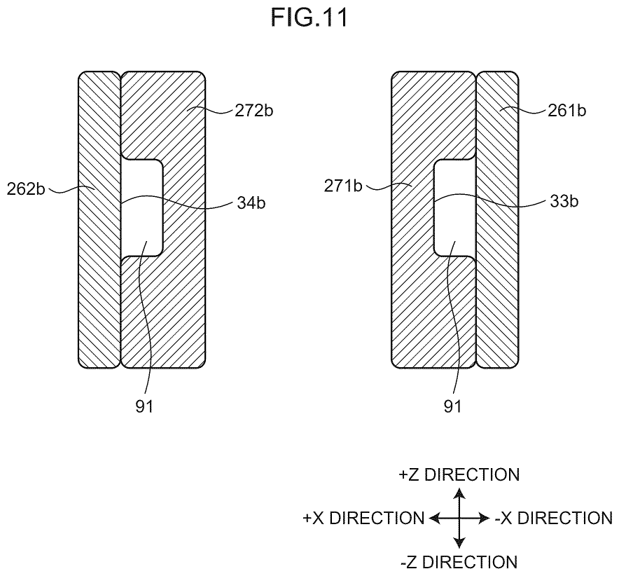

FIG. 10 is a top view of an internal structure of the second-phase arc-extinguishing chamber of the switch according to a second modification of the second embodiment. FIG. 11 is a cross-sectional view of the internal structure of the second-phase arc-extinguishing chamber of the switch according to the second modification of the second embodiment. FIG. 11 illustrates a cross section of the second-phase arc-extinguishing chamber 21b taken along line XI-XI in FIG. 10. In the switch 1 according to the second modification of the second embodiment, grooves 33b and 34b extending in the Y direction are formed in the insulators 271b and 272b, respectively. In the switch 1 according to the second modification of the second embodiment, internal spaces of the grooves 33b and 34b each serve as the gap 91 to form the return flow paths X2 and X3.

As described above, it is sufficient that the return flow paths X2 and X3 are configured by any surface which is at least a part of the side surface portion 261b or the side surface portion 262b of the grid 26b and the insulator 271b or the insulator 272b, and are separated from the return flow path X1.

The switch 1 according to the second embodiment includes the return flow path X1 through which the gas flow of the hot gas generated between the movable contact 25b and the fixed contact 24b flows in the +Y direction, and the return flow paths X2 and X3 through each of which the gas flow of the hot gas redirected by the coupling portion 263b flows in the −Y direction. Therefore, the gas flow of the hot gas generated between the movable contact 25b and the fixed contact 24b and the gas flow of the hot gas returned around the movable contact 25b and the fixed contact 24b can be intensified, and a counteraction therebetween can be suppressed. Therefore, the switch 1 according to the second embodiment achieves an effect similar to that of the switch 1 according to the first embodiment, and in addition thereto, can complete the cutting off of the arc at a higher speed by more quickly extending the arc to the grid 26b and dividing the arc.

The hot gas is not always necessary to branch off into the ±X directions at the coupling portion 263b. Therefore, a similar effect can be obtained even if the gas flow of the hot gas is caused to flow through at least one of the return flow path X2 and the return flow path X3.

### Third Embodiment

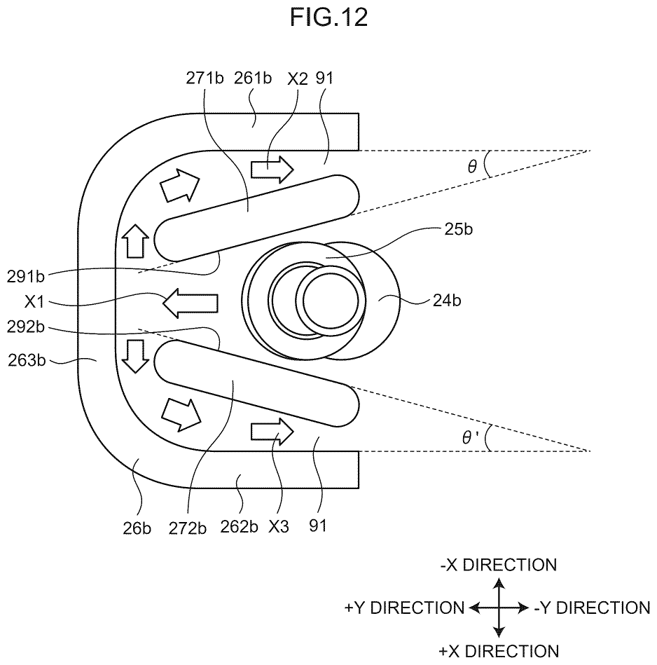

FIG. 12 is a top view of an internal structure of the second-phase arc-extinguishing chamber of the switch according to a third embodiment. The switch 1 according to the third embodiment is different from the switch 1 according to the second embodiment in that the insulators 271b and 272b are installed so that wall surfaces 291b and 292b of the insulators 271b and 272b facing the fixed contact 24b are inclined with respect to the side surface portions 261b and 262b of the grid 26b, respectively.

As illustrated in FIG. 12, in the switch 1 according to the third embodiment, the insulator 271b is disposed so that the wall surface 291b and the side surface portion 261b form an angle θ on an XY plane, and similarly, the insulator 272b is disposed so that the wall surface 292b and the side surface portion 262b form an angle θ′ on the XY plane. Here, the angle θ and the angle θ′ are not always necessary to have the same magnitude.

Similarly to the switch 1 according to the modification of the second embodiment, it is also possible to employ a configuration in which the insulators 271b and 272b include the low portions 31b and 32b, respectively.

In the switch 1 according to the third embodiment, the wall surfaces 291b and 292b of the insulators 271b and 272b facing the fixed contact 24b are inclined with respect to the side surface portions 261b and 262b of the grid 26b, and the insulators 271b and 272b become closer to the movable contact 25b and the fixed contact 24b with increasing closeness to the coupling portion 263b along the Y direction, so that a flow velocity of the gas flow of the hot gas flowing through the return flow path X1 increases. Therefore, the switch 1 according to the third embodiment can complete the cutting off of the arc at a higher speed by strengthening a force of the gas flow of the hot gas for driving the arc to thereby quickly extend the arc to the grid 26b and divide the arc.

### Fourth Embodiment

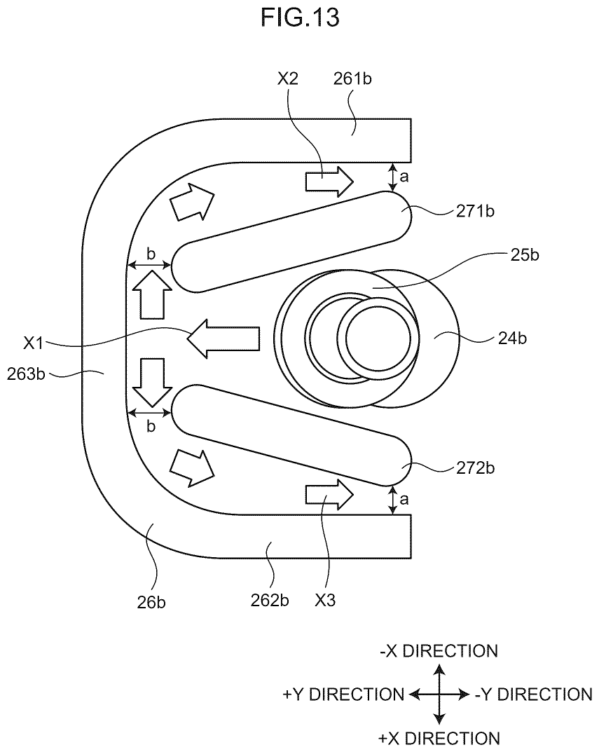

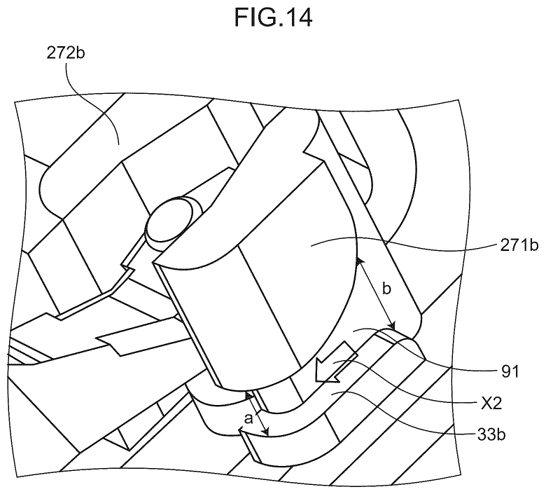

FIG. 13 is a top view of an internal structure of the second-phase arc-extinguishing chamber of the switch according to a fourth embodiment. In the switch 1 according to the fourth embodiment, the insulators 271b and 272b are installed so that the area of a gas outflow surface “a” for a gas flowing out from each of the return flow paths X2 and X3 is smaller than the area of a gas inflow surface “b” for a gas flowing from the return flow path X1 to each of the return flow paths X2 and X3. Here, the area of the gas outflow surface “a” and the area of the gas inflow surface “b” of each of the return flow paths X2 and X3 are not always necessary to coincide with each other, and it is satisfactory as long as the area of the gas outflow surface “a” <the area of the gas inflow surface “b” holds in each of the return flow paths X2 and X3.

FIG. 14 is a perspective view of an internal structure of the second-phase arc-extinguishing chamber of the switch according to a modification of the fourth embodiment. In FIG. 14, the grid 26b is not illustrated. Similarly to the insulator 271b of the switch 1 according to the second modification of the second embodiment, in the insulator 271b of the switch 1 according to the modification of the fourth embodiment, the inside of the groove 33b formed in the insulator 271b and extending in the first direction serves as the gap 91 to form the return flow path X2. In the switch 1 according to the modification of the fourth embodiment, the cross-sectional area of the groove 33b increases with increasing closeness to the coupling portion 263b. Although not illustrated in FIG. 14, similarly to the insulator 272b of the switch 1 according to the second modification of the second embodiment, the groove 34b similar to the groove 33b of the insulator 271b is formed in the insulator 272b, and the inside of the groove 34b serves as the gap 91 to form the return flow path X3. Therefore, in the switch 1 according to the modification of the fourth embodiment, the area of the gas outflow surface “a” for a gas flowing out from each of the return flow paths X2 and X3 is smaller than the area of the gas inflow surface “b” for a gas flowing from the return flow path X1 to each of the return flow paths X2 and X3.

Similarly to the switch 1 according to the first modification of the second embodiment, it is also possible to employ a configuration in which the insulators 271b and 272b include the low portions 31b and 32b, respectively. In the configuration in which the insulators 271b and 272b include the low portions 31b and 32b, respectively, a structure can be employed in which the height of each of the low portions 31b and 32b decreases with increasing closeness to the coupling portion 263b along the Y direction, and thereby the area of the gas outflow surface “a” for a gas flowing out from each of the return flow paths X2 and X3 is smaller than the area of the gas inflow surface “b” for a gas flowing from the return flow path X1 to each of the return flow paths X2 and X3. Alternatively, a structure may be employed in which a difference in height between the side surface portions 261b and 262b of the grid 26b and the low portions 31b and 32b of the insulators 271b and 272b increases with increasing closeness to the coupling portion 263b along the Y direction, and thereby the area of the gas outflow surface “a” for a gas flowing out from each of the return flow paths X2 and X3 is smaller than the area of the gas inflow surface “b” for a gas flowing from the return flow path X1 to each of the return flow paths x2 and X3. Alternatively, a structure may be employed in which a dimension of each of the return flow paths X2 and X3 in the X direction increases with increasing closeness to the coupling portion 263b along the Y direction, and thereby the area of the gas outflow surface “a” for a gas flowing out from each of the return flow paths X2 and X3 is smaller than the area of the gas inflow surface “b” for a gas flowing from the return flow path X1 to each of the return flow paths X2 and X3.

In the switch 1 according to the fourth embodiment, the area of the gas outflow surface “a” of each of the return flow paths X2 and X3 is smaller than the area of the gas inflow surface “b” thereof, and the return flow paths X2 and X3 are each narrowed in a direction of the flow, so that it is possible to increase a flow velocity of a gas flow blown onto the movable contact 25b and the fixed contact 24b. Therefore, the switch 1 according to the fourth embodiment can further enhance the arc cooling effect and can complete the cutting off of the arc more reliably than the switches 1 according to the first to third embodiments.

### Fifth Embodiment

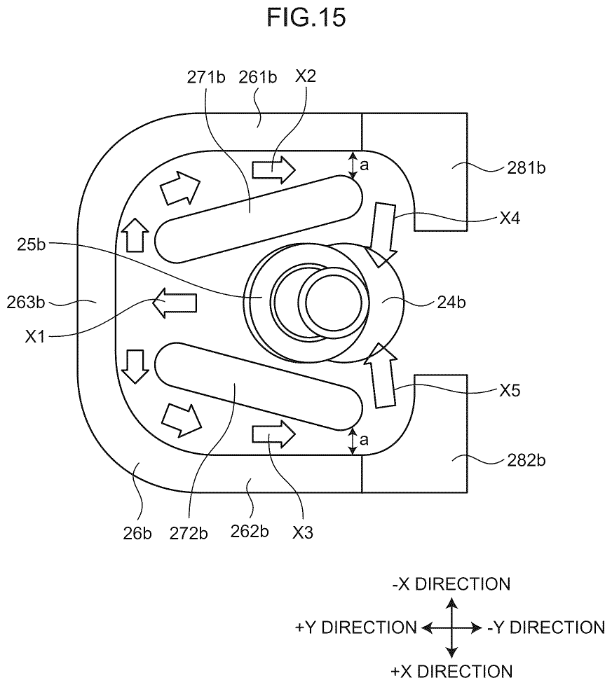

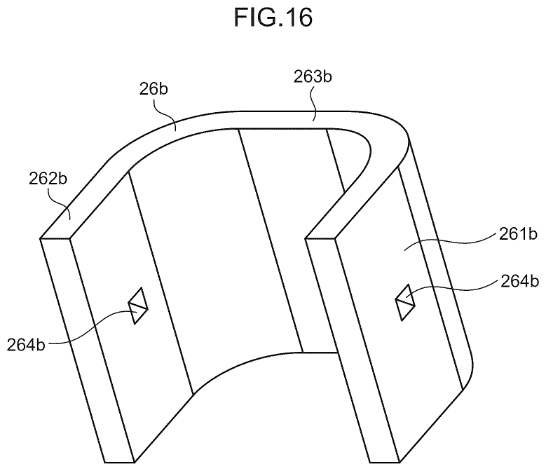

FIG. 15 is a top view of an internal structure of the second-phase arc-extinguishing chamber of the switch according to a fifth embodiment. The switch 1 according to the fifth embodiment includes gas blowing members 281b and 282b, which is a difference from the switch 1 according to the fourth embodiment. The gas blowing members 281b and 282b are installed adjacent to end portions of the side surface portions 261b and 262b, respectively, on the side opposite to the side connected to the coupling portion 263b. The surfaces of the gas blowing members 281b and 282b facing the fixed contact 24b are curved surfaces that become closer to the fixed contact 24b with increasing distance from the coupling portion 263b.

By providing the gas blowing members 281b and 282b on the return flow paths X2 and X3 on a side of the gas outflow surface “a”, a return flow path X4 is formed in a space sandwiched between the insulator 271b and the gas blowing member 281b, and a return flow path X5 is formed in a space sandwiched between the insulator 272b and the gas blowing member 282b.

Part of the hot gas generated together with the arc between the movable contact 25b and the fixed contact 24b during contact opening flows in a direction from the movable contact 25b or the fixed contact 24b toward the grid 26b. The hot gas that has hit the coupling portion 263b branches off into each of the ±X directions orthogonal to the Z direction which is the movable direction of the movable contactor 22b. The hot gas flows along an inner surface of the grid 26b through the return flow paths X2 and X3 in the −Y direction which is opposite to the direction of the gas flow of the hot gas in the return flow path X1. The traveling directions of the hot gases flowing through the return flow paths X2 and X3 are changed by the gas blowing members 281b and 282b, respectively. The gas flow of the hot gas flows in a direction toward the movable contact 25b and the fixed contact 24b in each of the return flow paths X4 and X5, and the hot gas is blown onto the movable contact 25b and the fixed contact 24b.

The switch 1 according to the fifth embodiment can efficiently blow the hot gas onto the movable contact 25b and the fixed contact 24b, and thus can enhance the arc cooling effect and can complete the cutting off of the arc more reliably.

### Sixth Embodiment

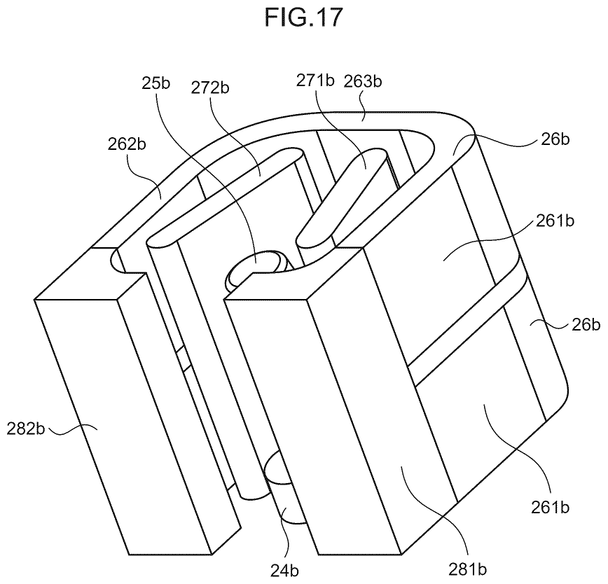

The switch 1 according to a sixth embodiment is different from the switch 1 according to the second embodiment in that the structure of the grid 26b is different. FIG. 16 is a perspective view of the grid of the switch according to the sixth embodiment. In the switch 1 according to the sixth embodiment, at least one through hole 264b is provided in at least one of the side surface portions 261b and 262b of the grid 26b, and a space inside and a space outside the grid 26b are connected via the through hole 264b. The rest of the configuration is similar to that of the switch 1 according to the second embodiment.

By providing at least one through hole 264b in at least one of the side surface portions 261b and 262b, part of the hot gas flowing through the return flow paths X2 and X3 is discharged outside the return flow paths X2 and X3 by the through hole 264b.

When the gas flow of the hot gas is impaired in the return flow paths X2 and X3, the inflow of the gas flow of the hot gas from the return flow path X1 is also impaired, and the driving of the arc by the gas flow of the hot gas flowing in the +Y direction in the return flow path X1 is weakened. In addition, the impairment of the inflow of the gas flow from the return flow path X1 to the return flow paths X2 and X3 decreases the gas flow to be returned around the fixed contact 24b and the movable contact 25b. Since the switch 1 according to the sixth embodiment can appropriately discharge the gas flow of the hot gas flowing through the return flow paths X2 and X3 to the outside of the return flow paths X2 and X3, the hot gas is returned around the movable contact 25b and the fixed contact 24b without staying in the return flow paths X2 and X3. Therefore, the switch 1 according to the sixth embodiment achieves the effects of the switches 1 according to the first to fifth embodiments, and in addition thereto, can increase return efficiency indicating a ratio of the hot gas to be returned around the movable contact 25b and the fixed contact 24b out of the hot gas generated between the movable contact 25b and the fixed contact 24b and can complete the cutting off of the arc more reliably.

### Seventh Embodiment

The switch 1 according to a seventh embodiment is different from the switch 1 according to the third embodiment in that the structure of the grid 26b is different. FIG. 17 is a perspective view of an internal structure of the second-phase arc-extinguishing chamber of the switch according to the seventh embodiment. In the switch 1 according to the seventh embodiment, a plurality of grids 26b are stacked in the movable direction of the movable contactor 22b. Here, the grids 26b of respective layers are not electrically connected to each other. The rest of the configuration is similar to that of the internal structure of the second-phase arc-extinguishing chamber 21b of the switch 1 according to the fifth embodiment.

Similarly to the first embodiment, the arc generated between the movable contact 25b and the fixed contact 24b is pulled by the plurality of grids 26b thus stacked, and connects the movable contact 25b and the fixed contact 24b with the coupling portion 263b of any of the grids 26b in the middle therebetween. Thereafter, the grids 26b are electrically connected, and with the movable contactor 22b and the fixed contactor 23b at both ends, the arc is divided by the grids 26b.

When an arc is drawn into any of the plurality of grids 26b, the switch 1 according to the seventh embodiment can divide the drawn arc by the plurality of grids 26b, and thus can increase an arc voltage and can complete the cutting off of the arc more reliably.

In each of the first to seventh embodiments, the contact switch including one pair of contacts per phase has been described. However, a contact switch including a plurality of contact pairs per phase can also be similarly implemented, and the scope of use thereof is not limited.

The configurations described in the embodiments above are merely examples of the content and can be combined with other known technology and part of the configurations can be omitted or modified without departing from the gist thereof.

### Reference Signs List

1 switch; 1A contact unit; 1B switching mechanism unit; 1C relay unit; 21a first-phase arc-extinguishing chamber; 21b second-phase arc-extinguishing chamber; 21c third-phase arc-extinguishing chamber; 22b movable contactor; 23a, 23b, 23c fixed contactor; 23d, 23e, 23f fixed terminal; 24b fixed contact; 25b movable contact; 26b grid; 31b, 32b low portion; 33b, 34b groove; 91 gap; 221b drive shaft; 231a, 231b, 231c power supply-side terminal; 231d, 231e, 231f load-side terminal; 261b, 262b side surface portion; 263b coupling portion; 264b through hole; 271b, 272b insulator; 281b, 282b gas blowing member; 291b, 292b wall surface.

1. A switch comprising:
a fixed contact;
a movable contact:
installed on a movable contactor that is rotationally movable having a rod-shape; and
separated from the fixed contact along with rotational movement of the movable contactor;
a grid made of metal disposed to face the fixed contact in a second direction that is a direction orthogonal to a first direction and along a longitudinal direction of the movable contactor, the first direction being a movable direction of the movable contact; and
at least one insulator installed between the grid and the fixed contact, wherein
the grid includes two side surface portions that face each other with the movable contact interposed therebetween in a third direction that is a direction orthogonal to each of the first direction and the second direction, and
the insulator is installed between at least one of the two side surface portions and the fixed contact, wherein
the grid is adapted to return a gas flow back around the movable contact and the fixed contact, the gas flow being generated between the movable contact and the fixed contact during an opening operation in which the movable contact is moved away from the fixed contact, and flowing along the second direction from the movable contact and the fixed contact toward the grid.

2. The switch according to claim 1,
wherein
the grid includes a coupling portion that faces the fixed contact in the second direction and couples the two side surface portions,
the insulator exposes at least a part of the coupling portion of the grid when viewed from a position of the fixed contact, and
the coupling portion has a dimension in the first direction larger than or equal to a dimension in the second direction.

3. The switch according to claim 2, wherein
a gap is formed between the insulator and the side surface portion facing the insulator.

4. The switch according to claim 3, wherein
a return flow path through which the gas flow flows in a direction opposite to a direction from the fixed contact toward the coupling portion in the second direction is formed by the gap; and
in the gap, a cross-sectional area at an end portion closer to the coupling portion in the second direction is larger than a cross-sectional area at an end portion farther from the coupling portion.

5. The switch according to claim 3, wherein
the insulator includes a low portion that is a portion in which a distance from the fixed contact in the first direction is shorter than a distance between an end portion of the side surface portion in the first direction of the side surface portion that is facing and the fixed contact; and
the gap is formed above the low portion.

6. The switch according to claim 5, wherein
a height difference that is a distance between the low portion and an end surface of the insulator in the first direction increases with increasing closeness to the coupling portion along the second direction.

7. The switch according to claim 5, wherein
a dimension of the insulator at the low portion in the first direction increases with increasing closeness to the coupling portion along the second direction.

8. The switch according to claim 3, wherein
a groove extending in the second direction is formed in a surface of the insulator facing the side surface portion, and a space inside the groove forms the gap.

9. The switch according to claim 8, wherein
a dimension of the gap in the first direction increases with increasing closeness to the coupling portion along the second direction.

10. The switch according to claim 2, wherein
the insulator is installed so that a wall surface facing the fixed contact becomes closer to the fixed contact in the third direction with increasing closeness to the coupling portion along the second direction.

11. The switch according to claim 2, wherein
the grid comprises a gas blowing member adapted to change a traveling direction of a gas flow flowing along the side surface portion and to blow the gas flow onto the fixed contact.

12. The switch according to claim 2, wherein
the grid has a through hole formed in the side surface portion, the through hole communicating a space surrounded by the coupling portion and the side surface portion with outside of the space.

13. The switch according to claim 1, wherein
a plurality of grids, the grids each identical with the grid, are stacked and disposed along the first direction.
